(19) United States
(12) Patent Application Publication
(10) Pub. No.: US 2024/0318824 A1
(43) Pub. Date: Sep. 26, 2024

(54) OVEN

(71) Applicant: E.G.O. Elektro-Gerätebau GmbH, Oberderdingen (DE)

(72) Inventors: Benjamin Schäufele, Kraichtal (DE); Marius Gesell, Eppingen (DE); Jochen Rickert, Kürnbach (DE); Tilo Fucik, Walzbachtal (DE); Mario Funk, Karlsdorf-Neuthard (DE)

(21) Appl. No.: 18/437,541

(22) Filed: Feb. 9, 2024

(30) Foreign Application Priority Data
Mar. 24, 2023 (DE) 10 2023 107 504.7

(51) Int. Cl. F24C 7/06; F24C 7/04; F24C 7/08

(52) U.S. Cl. CPC F24C 7/062; F24C 7/043; F24C 7/087

(57) ABSTRACT

An oven has a muffle with a muffle upper side and a muffle ceiling and with a door. A radiant heating device is arranged on the muffle upper side or muffle ceiling, and extends in a surface area parallel to the muffle upper side and has a radiation direction downwards. Furthermore, a top heating device is arranged on the muffle upper side, which extends around the radiant heating device. The radiant heating device has a cover into the muffle or is covered thereby, wherein the cover is planar and closed, and is permeable for the heat radiating from the radiant heating device. The cover covers the radiant heating device, wherein the top heating device surrounds the radiant heating device or extends outside of it.

### CROSS-REFERENCE TO RELATED APPLICATIONS

This application claims priority to German Application No. 102023107504.7, filed Mar. 24, 2023, the contents of which are hereby incorporated herein in its entirety by reference.

### FIELD OF APPLICATION AND PRIOR ART

The invention relates to an oven with a muffle, on the upper side of which a top heating device and in addition a radiant heating device are arranged. An improved grill function can be achieved in the oven with such radiant heating devices.

An oven of this type is known from U.S. Pat. No. 8,513,573. A ceramic heating element is used here to generate sufficient radiant heat to grill meat, for example from a short distance underneath it.

### OBJECT AND SOLUTION

The object of the present invention is to provide an oven as stated above with which prior art problems can be solved and which in particular makes it possible to heat the muffle of the oven with a high proportion of radiant heat and in particular to enable meat or the like to be grilled. The oven should have a practical design.

This object is achieved by an oven having the features of claim 1. Advantageous and preferred embodiments of the invention are the subject matter of further claims and are explained in greater detail below. The wording of the claims is incorporated by express reference into the content of the description.

The oven has a muffle with muffle upper side and a door, which can be opened in known manner, for sealing the muffle. A muffle ceiling is provided at the muffle upper side as the upper border of the muffle. Also, a radiant heating device is arranged on the muffle upper side for the aforementioned grill function, wherein the radiant heating device extends in a surface area parallel to the muffle upper side and has a radiation direction downwards into the muffle. Preferably, this radiation direction is substantially vertically downwards. In addition, a top heating device is also arranged on the muffle upper side, which extends around the radiant heating device and is thus designed planar, covering a large surface area.

In accordance with the invention, the radiant heating device or the oven has a cover into the muffle, wherein the cover is planar and closed, having no penetrations. It is permeable for the heat radiating from the radiant heating device, in particular with a transmittance of more than 90% or more than 95% for this heat radiation, wherein said cover is preferably transparent. The cover covers the radiant heating device in the vertical projection or covers it relative to the muffle, so that it is also free from direct fouling. Furthermore, the cover can thus also cover a possible opening in the muffle ceiling, through which the radiant heating device extends or radiates. Finally, the top heating device surrounds the cover and/or the radiant heating device or extends outside of it, such that it is not heated by the radiant heating device and above all does not shield food which is to be grilled/cooked from being grilled using the radiant heating device. Advantageously, the top heating device extends outside of it when seen in the vertical projection. A lateral/horizontal distance to the radiant heating device and/or to the cover may be between 1 cm and 10 cm. Advantageously, the top heating device is arranged in a plane underneath the radiant heating device.

The cover of the radiant heating device enables it to be protected from fouling, and furthermore electrical insulation from exposed electrically conducting parts, or directly from heating conductors of the radiant heating device itself, is also provided. The cover may in some cases also be used for fastening or holding the radiant heating device, which is explained in more detail in the following.

In a development of the invention, the radiant heating device can be arranged higher than the top heating device. A plane in which the radiant heating device extends can be higher than a plane in which the top heating device extends. The height difference can be in particular 1 cm to 5 cm. Regarding the height, this includes a plane in which a heating conductor of the radiant heating device extends, i.e. the plane from which the radiant heat is emitted.

In a further development of the invention, the cover can extend above the top heating device or above a plane in which the top heating device extends. This may also be because the cover may be fastened to the muffle ceiling or to the underside of the muffle ceiling. The top heating device in turn is also fastened to the underside of the muffle ceiling, advantageously with a distance of a few centimeters, for example 1 cm to 5 cm, as is usual.

In an embodiment of the invention, the preferably vertical distance of the cover to the radiant heating device or above all to a heating conductor of the radiant heating device can be up to 0.5 cm to 2 cm, in particular it can be at least 0.5 cm. This allows a total structural height to be kept relatively low.

In a further embodiment of the invention, the top heating device can be designed as a tubular heating element, for example in accordance with U.S. Pat. No. 2,973,572 or DE 10 2009 048 495 A1. Advantageously, the top heating device or a tubular heating element that forms it extends at least once by at least 66% around the radiant heating device or surrounds the radiant heating device by a corresponding proportion. Particularly advantageously this is up to 95%, i.e. almost completely.

In an embodiment of the invention, the radiant heating device has a heating conductor which can be designed preferably in strip form. Advantageously, this is a strip standing or arranged upright and made from a metal heating conductor material. The heating conductor preferably extends or runs substantially exposed and is fastened to or on a planar carrier. Particularly preferably, the heating conductor is at least partially inserted into the carrier to hold it, for example by a percentage of 1% to 20% of its height. In particular, the heating conductor on the carrier can extend along concentric circles and/or in a meandering form, i.e. in loops. Mixed forms are also possible, as is known per se. The heating conductor should cover the largest possible surface area of the radiant heating device, which distinguishes this embodiment from, for example, a radiant heater consisting of tubular heating elements and designed in linear form.

In a further embodiment, the radiant heating device can have a peripheral element, extending around the carrier or integrally formed or fixed to the carrier, which projects upwards past the carrier and past the heating conductor. The peripheral element is designed preferably annular or as an all-round ring. The peripheral element can thus limit the extent of the heating conductors, and hence a heated surface. Furthermore, it can be designed as a kind of spacer to the cover, which the radiant heating device is then in contact with by the peripheral element. Advantageously, the peripheral element is the only part of the radiant heating device which passes through the muffle ceiling or reaches the plane of the muffle ceiling or extends therein. Advantageously, a radiant heating device may be designed as known from U.S. Pat. No. 5,498,853 or EP 542 128 A2.

In an embodiment of the invention, the cover is held on the muffle ceiling, preferably by means of metal clips which are arranged on the edge of the cover and there hold the cover on the muffle ceiling or on its underside, in particular pressing it there. These metal clips can be fastened as required to the muffle ceiling, for example bolted or riveted or glued in place. Advantageously, the cover extends underneath the plane of the muffle ceiling or is in contact with the underside of the muffle ceiling. The metal clips can be detachable to remove the cover, for example to clean it. To do so, the metal clips can be released, opened or simply turned to the side. In addition, it is possible with the heat generated by the heating conductor of the radiant heating device to achieve pyrolysis on the cover, arranged very close, or a self-cleaning effect thereon, in particular when the cover consists of glass or a glass-like material. For this purpose, a specific operating mode of the radiant heating device can be provided if required.

In a further embodiment of the invention, the muffle ceiling may be designed like the rest of the muffle, in particular consisting of sheet metal, and preferably be enameled. It can be designed in one piece with another wall of the muffle or be fastened thereto. Preferably, the muffle ceiling has an opening for the radiant heating device which is between 0.5 cm and 5 cm larger than said radiant heating device or has a correspondingly larger diameter. The radiant heating device or heating conductors thereof can be arranged in or above the plane of the muffle ceiling and concentrically to the opening. Preferably, the radiant heating device is arranged in the opening and can project downwards out of the opening. The heating conductors are then arranged in a plane above the muffle ceiling, for example higher by the aforementioned 0.5 cm to 2 cm.

Generally speaking, the radiant heating device should not be arranged towards one of the side walls on a peripheral area of the muffle ceiling, but rather in the center or in a middle area. An area or a grill area heated using the radiant heating device can thus be located more in the center of the muffle or in a middle area of an inserted grill. This permits practical handling of the oven with the grill function or during operation of the radiant heating device. Advantageously, the radiant heating device can cover the center of a surface area of the muffle upper side or muffle ceiling. The radiant heating device can here in particular be arranged in the middle of the muffle upper side or muffle ceiling.

In an advantageous embodiment of the invention, a single radiant heating device for a grill function or with permanently red-hot heating conductors, which have a normal or required operating temperature of more than 900° C. and in particular more than 1.000° C., is provided on the oven or on its muffle ceiling. An aforementioned standard top heating device in the form of a tubular heating element is not considered here to be such a radiant heating device. This single radiant heating device should have a single basic geometrical shape, advantageously circular, alternatively rectangular or square.

In a further embodiment of the invention, the radiant heating device can be designed as a multiple-circuit heater for differently sized grill areas, wherein a multiple-circuit heater preferably has precisely two or precisely three of the aforementioned heating conductors. These grill areas then not only differ in their design, but also differ in their size, to adjust to the quantity and/or size of food to be grilled, for example one, two or three steaks. The heating conductors are separately controllable. Advantageously, different areas in which precisely one such heating conductor extends in each case are separated from one another by an aforementioned peripheral element, so that they do not over-radiate in the lateral direction.

These and further features are revealed in the description and in the drawings as well as in the claims, wherein the individual features can each be realized singly or severally in the form of sub-combinations in one embodiment of the invention and in other fields, and can represent embodiments advantageous and protectable per se, for which protection is claimed here. The subdivision of the application into individual sections and sub-headings does not limit the statements made thereunder in their general validity.

### BRIEF DESCRIPTION OF THE DRAWINGS

An example of the invention is shown schematically in the drawings and is explained in more detail in the following. In the drawings:

FIG. 1 shows a view of an oven in accordance with the invention from the front and into the muffle, with top heater and radiant heater on a muffle ceiling,

FIG. 2 shows a view of the muffle ceiling from FIG. 1 from below and

FIG. 3 shows an oblique view of the radiant heater on the muffle ceiling.

### DETAILED DESCRIPTION OF THE EXAMPLE

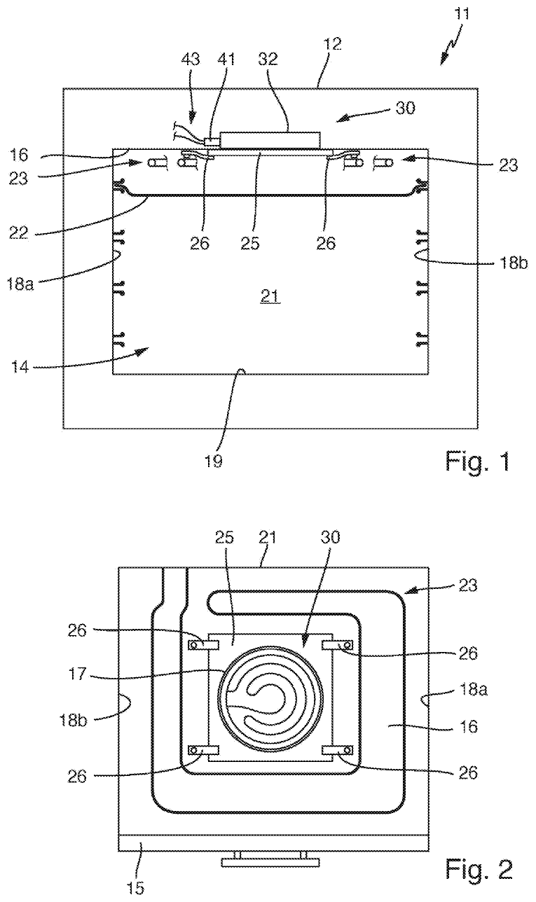

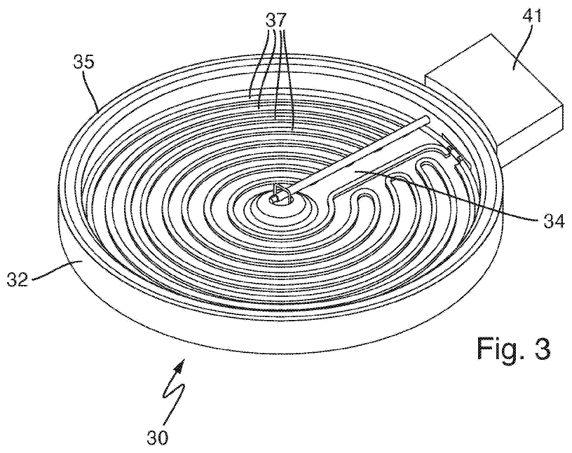

FIG. 1 shows an oven 11 in accordance with the invention, and open to the front. The oven 11 has an oven housing 12 and therein a muffle 14 as the interior. The muffle 14 can, in accordance with the bottom view in FIG. 2, be closed in the usual manner with a door 15. The muffle 14 is thus bordered to the front by the door 15, upwards by a muffle ceiling 16, to the left by a left-hand muffle side wall 18a, to the right by a right-hand muffle side wall 18b, downwards by a muffle floor 19 and rearwards by a muffle rear wall 21. It is thus designed substantially box-like or cube-like in the usual way. Holders for a grill 22, indicated schematically, are arranged on the muffle side walls 18a and 18b in the usual way, preferably in the manner of rails for insertion. They allow a grill 22 or a baking tray to be arranged or inserted at different levels, in particular at different distances from the muffle ceiling 16. For grilling a piece of meat or a steak, the grill 22, as shown here, can be advantageously inserted in the topmost position. The grill 22 can be generally and advantageously be designed as a cast-metal grill or consist at least partially of cast iron. Preferably, it can be designed in solid cast iron and consist completely of cast iron.

A top heater 23 is arranged at the top, on the muffle upper side, or just below the muffle ceiling 16. Its arrangement can be discerned by way of example from the bottom view in FIG. 2; it extends here in a kind of loop. It is passed through the muffle rear wall 21 and has behind it the electrical connection; it can also be fastened in a known manner to the muffle ceiling 16 by means of holding plates or the like. The top heater 23 is advantageously formed by a standard tubular heating element, as is known and frequently used for top heating devices in ovens. Reference is made here for example to the aforementioned U.S. Pat. No. 2,973,572 or DE 10 2009 048 495 A1, which both show such tubular heating elements. A tubular heating element such as for the top heater 23 also has, after some time in operation, as a rule more than 5 minutes or more than 10 minutes, and with the maximum continuous power, a sufficiently high temperature to generate radiant heat to a significant extent. It can then reach temperatures of 800° C. or 900° C. and visibly glow as it does so, and generate a high proportion of radiant heat. However, the tubular heating element is not used for the top heater 23 or at least not mainly for the grill function required, for example. It would be too slow and ultimately not hot enough for that purpose. In addition, the tubular heating element radiates only partly directly onto the food due to its design and geometry, so that the total heat input would not be sufficiently high.

For this purpose, the radiant heater 30 is provided, which here has a round shape and is arranged approximately in the center of the muffle ceiling 16. The precise design of the radiant heater 30 is explained below in more detail with reference to FIG. 3. It has a metal dish 32 in which it is held, and a rod control housing 41 is provided on the outer periphery of the dish and also intended for electrical connection by means of connecting leads 43. The radiant heater 30 projects downwards a small distance into or though an opening 17 in the muffle ceiling 16. This opening 17 is also circular, like the radiant heater 30 itself, and has a clearance of a few millimeters, for example 2 mm, from it or is correspondingly larger. Underneath the opening 17, a rectangular or square cover glass 25 is fastened in the corner areas by means of metal clips 26. The cover glass 25 is, for example and advantageously, tempered glass or glass ceramic or quartz glass in order to withstand the occurring high temperatures of the radiant heater 30, which can be in the range from 1.000° C. to 1.200° C. At the same time, a maximum proportion of radiant heat should of course pass downwards through the cover glass 25, with the transmission for this being as high as possible. An advantageous cover glass 25 named Robax is made by Schott; alternatives would for example also be glass ceramics, as known from hobs. The transmission should be optimized to match the maximum temperature of the radiant heater 30 for the wavelength range to be expected, and be as high as possible.

It may be provided that the radiant heater 30 rests directly on the cover glass 25, and may even be substantially held by it. The cover glass 25 can thus support its weight. Further fastening means should be provided to prevent displacement in the lateral direction or lifting off, for example during assembly or transport of the finished oven 11. An at least partial fastening of this type for the radiant heater 30 also has the advantage that the metal clips 26 can then be designed such that they can, for example, be turned to the side for removal of the cover glass 25, without the radiant heater 30 dropping down into the muffle 14 or being suspended. This allows the cover glass 25 to be cleaned, in particular on its underside. This is considerably simpler to do in the removed state than in the assembled state. In addition, the top heaters 23 would then not be a hindrance.

It can also be readily discerned from FIG. 2 that the top heater 23 has a lateral distance from the radiant heater 30. This distance is quite large at around 10 cm, but it could also be smaller, to allow for example even more coils for the top heater 23 to be arranged, for example a total of three or even four parallel coils. At the same time, the surface coverage of the overall muffle ceiling 16 by the top heater 23 is still sufficient for it to operate steadily with a standard top heating function of the oven 11. Advantageously, a further standard fan heater, as is known from convection ovens, can be provided in the muffle 14. Furthermore, the oven 11 can also have a bottom heater, advantageously underneath the muffle floor 19 as is usual.

The diameter of the radiant heater 30 can generally be around 18 cm to 23 cm. Its output can be between 2 kW and 3 kW, such that it has a surface power of 5 W/cm2 to 9 W/cm2. In an alternative embodiment of the invention, the lateral distance between the radiant heater 30 and the top heater 23 could be considerably lower, so that either the top heater 23 is closer to the muffle ceiling 16 or more in its middle area, or the radiant heater 30 is considerably larger. Diameters of around 21 cm are however regarded as sufficient to permit grilling of two steaks, for example, on the grill 22. In a further embodiment of the invention, it is also conceivable to use an aforementioned multiple-circuit heater to obtain grill areas of differing size. Such multiple-circuit heaters are known from radiant heating devices in hobs.

FIG. 3 shows in an oblique representation the radiant heater 30, which can correspond to a standard radiant heater as stated at the outset. The radiant heater 30 has a flat and round carrier 34 on which a peripheral element 35 extending around the outside is fitted. Alternatively, a peripheral element can be integrally cast on in one piece. The carrier 34 and the peripheral element 35 are manufactured from electrically and thermally insulating material. A heating conductor 37, laid out in loops with a round and meandering form, is arranged on the top of the carrier 34, advantageously by insertion of holding members which project downwards from a lower heating conductor edge. The heating conductor 37 itself is advantageously designed thin and strip-like, as known from the aforementioned prior art. The peripheral element 35 projects 1 cm to 3 cm above the top edge of the heating conductor 37 and forms the topmost area of the entire radiant heater 30. The carrier 34 and the peripheral element 35 are placed into a sheet-metal dish 32 which enhances the mechanical stability of the entire radiant heater 30. The peripheral element 35 here projects by 1 mm to 10 mm above the sheet-metal dish 32. If the radiant heater 30 rests on the cover glass 25, then the peripheral element 35 rests directly thereon.

A standard rod control 40 is provided slightly above the heating conductors 37 and extending over a free area of the latter. It is used for maintaining a maximum working temperature of the radiant heater 30 or of the heating conductors 37. The corresponding switch is arranged in a rod control housing 41. The ends of the strip-like heating conductor 37 too are routed into the rod control housing 41 and connected there to terminal lugs that project from the side or rear of the rod control housing 41. They are not illustrated here for the sake of clarity. Corresponding plug sockets of the connecting leads 43, as shown in FIG. 1 at the left above the radiant heater 30, are connected to these terminal lugs. A rod control of this type is however not essential. This depends on the surface power of the heating conductors 37 or of the radiant heater 30. It is used, similarly to what is known from a glass ceramic hob, to protect the cover glass 25 from overheating and resultant damage.

A further advantage of using a radiant heater 30 in the embodiment described here with a thin metal heating conductor 37 extending in loops or in meandering form is that in comparison to ceramic heating elements or even tubular heating elements, it very quickly reaches its operating temperature and generates radiant heat. This can be achieved in less than 5 sec, advantageously in around 3 sec. The grill function is thus available very quickly. Compared to ceramic heating elements possibly in use, a higher temperature can be achieved, and a targeted or directed heat radiation into the food to be grilled is effected.

It may be discerned from the known arrangement of the heating conductors 37 on the carrier 34 with surrounding peripheral element 35, as shown in FIG. 3, that an emission direction of the radiant heat is substantially vertical to the surface area of the carrier 34. It is thus also easily conceivable that in the installed state according to FIG. 1, the radiant heater 30 radiates downwards, but without a noticeably wide opening angle. As a result, and above all in the case of a short distance as shown in the grill 22, a surface area somewhat larger than the radiant heater 30 itself is substantially subjected to the predominant proportion of the radiant heat. The area suitable for grilling is thus not particularly large, but due to its concentration the radiant heat is very high there, so that a grill function can be easily performed.

The rod control 40 can be rated for temperatures of around 600° C. to 700° C. for switch-off. As a result, too high temperatures at the cover glass 25 are avoided.

1. An oven with
a muffle with a muffle upper side and with a door, said door being openable, for sealing said muffle,
a muffle ceiling as an upper border of said muffle at said muffle upper side,
a radiant heating device on said muffle upper side, wherein said radiant heating device extends in a surface area parallel to said muffle upper side and has a radiation direction downwards into said muffle
a top heating device on said muffle upper side, wherein said top heating device extends around said radiant heating device,
wherein:
said radiant heating device has a cover into said muffle, wherein said cover is planar and closed, having no penetrations, and is permeable for said heat radiating from said radiant heating device,
said cover covers said radiant heating device in a vertical projection,
said top heating device surrounds said radiant heating device or extends outside of said radiant heating device.

2. The oven according to claim 1, wherein said radiant heating device is arranged higher than said top heating device.

3. The oven according to claim 2, wherein a plane in which said radiant heating device extends is higher than a plane in which said top heating device extends.

4. The oven according to claim 1, wherein said cover extends above said top heating device or above a plane in which said top heating device extends.

5. The oven according to claim 1, wherein a distance of said cover to said radiant heating device or to a heating conductor of said radiant heating device is 0.5 cm to 2 cm.

6. The oven according to claim 1, wherein said top heating device surrounds said radiant heating device or said cover at a horizontal distance, wherein said horizontal distance is between 1 cm and 10 cm.

7. The oven according to claim 1, wherein said top heating device is designed as a tubular heating element.

8. The oven according to claim 7, wherein said top heating device is designed to surround said radiant heating device at least once by at least 66%.

9. The oven according to claim 1, wherein said radiant heating device has a heating conductor being substantially exposed and being fastened to a planar carrier.

10. The oven according to claim 9, wherein said heating conductor is at least partially inserted into said carrier to hold it.

11. The oven according to claim 9, wherein said radiant heating device has a peripheral element, extending around said carrier, said peripheral element projecting past said carrier and past said heating conductor, wherein said radiant heating device is in contact with said cover by said peripheral element.

12. The oven according to claim 11, wherein said peripheral element is the only part of said radiant heating device to pass through said muffle ceiling or to reach a plane of said muffle ceiling or extends in said muffle ceiling.

13. The oven according to claim 1, wherein said cover is held on said muffle ceiling.

14. The oven according to claim 13, wherein said cover extends underneath a plane of said muffle ceiling or is in contact with said underside of said muffle ceiling.

15. The oven according to claim 1, wherein said muffle ceiling has an opening which is between 0.5 cm and 5 cm larger than said radiant heating device, wherein said radiant heating device or heating conductors of said heating device are arranged in or above a plane of said muffle ceiling and concentrically to said opening.

16. The oven according to claim 15, wherein said radiant heating device is arranged in said opening.

17. The oven according to claim 1, wherein said radiant heating device covers a center of a surface area of said muffle upper side or of said muffle ceiling.

18. The oven according to claim 17, wherein said radiant heating device is arranged in a middle of said muffle upper side or of said muffle ceiling.

19. The oven according to claim 1, wherein said radiant heating device is a multiple-circuit heater for differently sized grill areas, wherein said radiant heating device has a heating conductor being substantially exposed and is fastened to a planar carrier, wherein a multiple-circuit heater has precisely two or precisely three of said heating conductors, said heating conductors being separately controllable.

20. The oven according to claim 19, wherein a peripheral element is provided, said peripheral element extending around said carrier and projecting past said carrier and past said heating conductor, wherein said radiant heating device contacts said cover with said peripheral element, wherein different areas in which precisely one such heating conductor extends in each case are separated from one another by said peripheral element.

21. The oven according to claim 1, wherein a grill for supporting food in said muffle is designed as a cast-metal grill and consists at least partially of cast iron or has at least partially cast iron.

22. The oven according to claim 21, wherein said grill is solid and consists completely of cast iron.
